(19) United States
(12) Patent Application Publication
(10) Pub. No.: US 2012/0108714 A1
(43) Pub. Date: May 3, 2012

(54) NONWOVEN AND YARN POLYPROPYLENE WITH ADDITIVATION

(75) Inventor: Manfred Wittner, Mannheim (DE)

(73) Assignee: LUMMUS NOVOLEN TECHNOLOGY GMBH, Mannheim (DE)

(21) Appl. No.: 13/284,209

(22) Filed: Oct. 28, 2011

Related U.S. Application Data
(60) Provisional application No. 61/407,719, filed on Oct. 28, 2010.

(51) Int. Cl. C08L 23/12; C08K 5/1575; B32B 17/02; C08K 5/20

(52) U.S. Cl. 524/108; 524/582; 524/226; 156/62.4

(57) ABSTRACT

A process to produce improved polypropylene nonwovens or yarns by extruding a mixture of polypropylene(s) and beta nucleating agent(s), or in the alternative, certain clarifiers, to form the improved polypropylene filaments.

### CROSS-REFERENCE TO RELATED APPLICATION

This application, pursuant to 35 U.S.C. §119(e), claims priority to U.S. Provisional Application Ser. No. 61/407,719, filed Oct. 28, 2010. That application is herein incorporated by reference in its entirety.

### FIELD OF THE DISCLOSURE

Embodiments disclosed herein relate generally to a spunbonding and a Bulked Continuous Filament process of a mixture of polypropylene and beta nucleating to form a fiber or a yarn, depending on the chosen process.

### BACKGROUND

A nonwoven composition or article is typically a web or fabric having a structure of individual fibers or threads which are randomly interlaid, but not in an identifiable manner. Nonwoven webs can be produced from polymeric strands by various techniques known in the art, including spunbonding and melt blowing. A Bulked Continuous Filament (BCF) composition or article is typically a filament bundle (yarn) composed out of individual filaments or threads having a voluminous structure.

Examples of the various types of spunbonded processes are described in U.S. Pat. No. 3,338,992 to Kinney, U.S. Pat. No. 3,692,613 to Dorschner, U.S. Pat. No. 3,802,817 to Matsuki, U.S. Pat. No. 4,405,297 to Appel, U.S. Pat. No. 4,812,112 to Balk, and U.S. Pat. No. 5,665,300 to Brignola et al, each of which is hereby incorporated by reference. In general, traditional spunbonded processes include: a) extruding the strands from a spinneret; b) quenching the strands with a flow of air which is generally cooled in order to hasten the solidification of the molten strands; c) attenuating the filaments by advancing them through the quench zone with a draw tension that can be applied by either pneumatically entraining the filaments in an air stream or by wrapping them around mechanical draw rolls of the type commonly used in the textile fibers industry; d) collecting the drawn strands into a web on a foraminous surface; and e) bonding the web of loose strands into a fabric. This bonding can use any thermal, chemical or mechanical bonding treatment known in the art to impart coherent web structures.

Examples of the various types of meltblowing processes are described in NRL Report 4364 “Manufacture of Superfine Organic Fibers” by V. A. Wendt, E. L. Boone, and C. D. Fluharty and in U.S. Pat. No. 3,849,241 to Buntin et al., among others, which is hereby incorporated by reference. Conventional meltblowing process generally involve: a) Extruding the strands from a spinneret; b) Simultaneously quenching and attenuating the polymer stream immediately below the spinneret using streams of high velocity heated air; c) Collecting the drawn strands into a web on a foraminous surface. Meltblown webs can be bonded by a variety of means, but often the entanglement of the filaments in the web or the autogenous bonding in the case of elastomers provides sufficient tensile strength so that it can be wound onto a roll. A meltblowing process which provides for the extrusion of multicomponent strands is described in, for example, U.S. Pat. No. 5,290,626, which is hereby incorporated by reference.

Examples of the Bulk Continuous Filament process are found in various patents including U.S. Pat. No. 3,447,296 to Chidgey, et al. and U.S. Pat. No. 6,447,703 to Waddington, et. al., which is hereby incorporated by reference.

Polypropylenes are one type of polymer commonly used to form spunbond and meltblown nonwovens and BCF yarns. Filament spinning speeds for the BCF, spunbonding and meltblowing processes are limited based on the specific polymeric materials processed, and the processability of Ziegler-Natta and metallocene polypropylenes are typically different. Ziegler-Natta polypropylenes, for example, have disadvantages in requiring a high draw force necessary to attenuate the filaments, and having a significant elongational viscosity decrease at high spinning speeds, which leads to unstable process conditions. Metallocene polypropylenes also show a decreasing elongational viscosity at very high spinning speeds (but to a lower degree than Ziegler-Natta), leading also to unstable process conditions (but at higher spinning speeds than Ziegler-Natta-PP's). A further disadvantage, especially for metallocene polypropylenes, is the narrow melting range, leading to a narrow thermal bonding process window, limiting the overall speed of the process for forming a nonwoven and inhibiting the optimal bonding which is responsible for reaching higher nonwoven tensile strengths.

### SUMMARY OF THE DISCLOSURE

A method is provided herein to improve the ability to process polyolefins into nonwoven fibers using the spunbonded, meltblown or Bulked Continuous Filament methods in which beta nucleators are added to the polymer to be processed.

In one aspect, embodiments disclosed herein relate to a process to produce polypropylene fibers for nonwoven webs, including: extruding a mixture comprising a polypropylene and a beta-nucleating agent to form fibers.

In another aspect, embodiments disclosed herein relate to a process to produce polypropylene yarn from the Bulk Continuous Fiber Process, including: extruding a mixture comprising a polypropylene and a beta-nucleating agent to form fibers.

In another aspect, embodiments disclosed herein relate to a process to produce nonwoven webs by the spunbonding process, including: a) blending the polypropylene and the beta-nucleating agent to form a mixture; b) extruding the mixture to form fibers; c) quenching the fibers; d) forming a web with the fibers; and e) bonding the fibers.

In another aspect, embodiments disclosed herein relate to a process to produce bulked yarn by the Bulk Continuous Fiber process, including: a) blending the polypropylene and the beta-nucleating agent to form a mixture; b) extruding the mixture to form yarns; c) quenching the yarns; d) crimping the yarns; e) winding the yarns on bobbins.

In another aspect, embodiments disclosed herein relate to a process to produce nonwoven webs by the meltblown process, including: a) blending the polypropylene and the beta-nucleating agent to form a mixture; b) extruding the mixture to form fibers; c) quenching the fibers; d) forming a web with the fibers; and e) bonding the fibers.

Other aspects and advantages will be apparent from the following description and the appended claims.

### BRIEF DESCRIPTION OF DRAWINGS

FIG. 1 shows a DSC curve for a non-beta nucleated polypropylene.

FIG. 2 shows a DSC curve for a beta nucleated polypropylene according to embodiments disclosed herein.

FIG. 3 shows a spunbonding process according to embodiments disclosed herein.

FIGS. 4-9 compare the melt and draw properties of mixtures comprising a polypropylene and a beta nucleating agent according to embodiments disclosed herein to the properties of comparative samples without a beta nucleating agent.

### DETAILED DESCRIPTION

In one aspect, embodiments herein relate generally to processes for forming nonwovens with polypropylene. More specifically, embodiments disclosed herein relate to spunbonding or meltblowing a mixture of polypropylene(s) and beta nucleating agent(s) to form nonwovens. A further embodiment disclosed herein relates to spinning of Bulked continuous Fibers with a mixture of polypropylene(s) and beta nucleating agent(s) to form yarns.

It has been unexpectedly found by the present inventor that beta nucleating agents may improve the processability of Ziegler-Natta and metallocene polypropylenes in spunbonding, meltblowing and BCF processes. The use of beta nucleating agents may yield improvements in one or more of the spinning, drawing (attenuating), and thermal bonding of the polypropylene. The advantages of the present invention can also be seen in Bulk Continuous Fiber (BCF) applications, namely in the melt spinning and crimping parts of the process, but not in the cold drawing of the fiber. The process for manufacturing melt-spun polymeric yarns of bulked continuous filaments (BCF) are known as evidence by following U.S. Pat. Nos. 5,804,115; 5,487,860; 4,096,226; 4,522,774 and 3,781,949, each of which is incorporated by reference. In general, such processes involve the continuous sequential operations of melting the polymer, extrusion of the polymer melt through dies to form a yarn (spinning), drawing the yarn in-between two godets with different speeds and texturing (crimping) of the yarn to provide bulkiness to the resulting BCF yarn.

The crimping process is the part of the BCF process which imparts a texture to the straight yarn. The crimping is realized by feeding the yarn into a steam heated stuffer-box. The lower exit speed will compress the heated yarn and subsequent cooling and re-crystallization of the exiting yarn will maintain the shape implied during the compression in the stuffer box. The inventors note that this is only one example of a crimping process used for BCF, and the present invention applies generally to BCF process.

It was previously believed that, for spunbond nonwoven processing, that nucleating agents negatively influence the spinning process due to precipitated crystallization, inhibiting a further attenuation of the polymer, which is crucial to obtain fine fiber diameters. For example, as noted in U.S. Pat. No. 5,908,594, when a semicrystalline polymer is drawn into a highly oriented state, as would occur during attenuation in the spunbonding and meltblowing processes, the tenacity and modulus of the polymer increases, but at the same time its elongation percentage to break decreases. This happens in varying degrees depending upon the crystallization behavior of the polymer. Improved performance was noted in the '594 patent for metallocene polypropylenes that exhibited an increase in amorphous content at higher draw rates or spinning speeds.

One skilled in the art would thus expect that the use of beta nucleating agents in any “hot draw” or “melt draw” processes, including those mentioned above, would result in premature crystallization, having a negative effect on the elongational viscosity, inhibiting a further attenuation of the filaments, and resulting in a decrease in process stability at higher processing speeds. The “hot- or melt draw” is a process in which a still molten polymer strand is drawn by a drawing force. During the “hot or melt” drawing initial crystallites are generated which further grow during the attenuation and cooling process. This “hot- or melt drawing” is therefore in contrast to the “cold drawing” where the crystals already exist and the drawing is realized at a certain temperature to facilitate crystal movement necessary for the stretching process.

It has been found, however, that use of beta nucleating agents when processing polypropylene unexpectedly has a positive influence on the elongational viscosity, providing higher spinning stability at very high process speeds. Without being bound to any particular theory, it is believed that the morphologic structure reached by adding the beta nucleating agents homogenizes the (draw) crystallization, without impacting the process due to premature crystallization, allowing for improved processability at higher process speeds and draw rates. The beta nucleating agents decrease the elongation viscosity of polypropylene at low to medium spinning speeds, and unexpectedly increase or retard the decay of elongational viscosity of the polymer at very high spinning velocities. These characteristics provide easier draw at standard process conditions, allowing production of a finer filament diameter, and a higher melt strength (higher process stability) at very high spinning speeds. The increased stability at very high spinning speeds is crucial for further filament drawing to obtain very fine fiber diameters without increasing the risk of filament breaks (fewer machine down-times and/or decreased amounts of off-spec material). Further, a decrease in the basis weight of the nonwoven may be possible due to the possibility to decrease the fiber diameter when using a beta nucleating agent. The inventors have also found that, alternatively, at least one clarifying agent, Milliken's NX8000, (1,2,3-trideoxy-4,6:5,7-bis-O-((4-propylphenyl)-methylene)-nonitol), also produces such benefits. But because of the varying chemical natures of clarifiers, the inventors cannot presently predict if other clarifiers would produce such results.

An additional positive effect of spunbond or meltblown polypropylene nonwovens using beta nucleating agents is that the beta nucleating agent additionally affects the melting characteristics of the polymer, and provides a positive thermal bonding behavior to the nonwoven fabric. The beta nucleated fiber or spunbond nonwoven fabric shows in contrast to the non-beta nucleated fiber or spunbond nonwoven fabric two melting peaks broadening therefore the whole melting range with a shift to lower melting temperatures. The broader melting range and the shift to lower melting temperature broaden the process window for the thermal bonding process. The thermal bonding is realized by passing the nonwoven through a pair of hot rollers of which one roller has an engraved bonding pattern and the second roller has a smooth surface. The high temperature of the rollers melt the filament surface, while the pressure in the nib of the rollers will press the filaments together finally creating a consolidated fabric or spunbond nonwoven respectively. Application of this aspect of the invention is especially important for metallocene polypropylenes, which are known to have a narrow bonding process window. Improvements in the bonding process window may lead to an increase in the overall speed of the nonwoven production process, and an increased tenacity of the nonwoven.

Use of beta-nucleating agents in polypropylene compositions for forming nonwovens by spunbonding or meltblowing and yarns by the BCF process may provide for higher fiber spinning stability at high velocities without increasing the risks of breaks in the fibers, leading to higher line throughputs hence a cost benefit for the production of fibers having smaller diameters, increased surface area, improved mechanical properties, such as, tensile strength, elongation and softness. Thus the nonwovens may have smaller fiber diameters, increased surface area, and improved mechanical properties. When used in applications, such as hygiene products, baby diapers, wipes, and absorbent pads, the smaller fiber diameters may provide for at least one of the following advantages—increased surface area for improved absorbency, lighter weight products, as well as enhanced mechanical strength and/or softness.

As mentioned above, it has been found that beta nucleating agents may be used to improve the spinning of polypropylenes, including Ziegler-Natta and metallocene polypropylenes, among others. Polypropylenes useful in embodiments disclosed herein may include polypropylene homopolymers and interpolymers (i.e., copolymers, terpolymers, etc.), including block, graft, impact, random, alternating, and multi-block interpolymers). Such polypropylenes may include atactic, isotactic, and syndiotactic polypropylenes.

As used herein, “polypropylene” refers to a polymer containing greater than 50 mole percent propylene monomer. Co-monomers that may be used to form various polypropylenes may include ethylene or a C4 to C20 alpha-olefin, such as 1-butene, 3-methyl-1-butene, 4-methyl-1-pentene, 3-methyl-1-pentene, 1-heptene, 1-hexene, 1-octene, 1-decene, 1-dodecene, and styrene, among others, including their halogenated counterparts, as well as conjugated or non-conjugated, straight chain, branched, or cyclic C4 to C20 dienes, such as butadiene, norbornene, pentadienes or cyclopentadienes, and 1,4-hexadiene, 1,6-octadiene, 1,7-octadiene, 1,9-decadiene, 5-methyl-1,4-hexadiene; 3,7-dimethyl-1,6-octadiene; and 3,7-dimethyl-1,7-octadiene, among others.

Polypropylenes useful in embodiments disclosed herein may have a melt flow rate (ISO 1133, 230° C. with 2.16 kg weight) in the range from 0.3 to 2000 g/10 min; in the range from about 0.9 to about 1000 g/10 min in other embodiments; and in the range from about 1 to about 500 g/10 min in yet other embodiments. The more preferable ranges may vary for Spunbond NW and melt blown. The melt flow rate for spunbound nonwoven process is in the range of about 10 to about 60 g/10 min, preferably from about 20 to about 40 g/10 min, and more preferably from about 25 to about 30 g/10 min. The melt flow rate for meltblow process is in the range from about 400 to about 2000 g/10 min, preferably from about 800 to 1500 g/10 min and more preferably from about 1000-1200 g/10 min.

In some embodiments, the polypropylene may be formed using a metallocene catalyst. Metallocene catalysts or catalyst systems employing a metallocene catalyst are described, for example, in U.S. Pat. Nos. 7,285,608, 7,232,869, 7,169,864, 7,544,826, and 7,629,464, among others, which are herein incorporated by reference. In various embodiments, the metallocene catalyst may include Novocene® 013 which is more fully described in U.S. Pat. No. 7,169,864. However, the inventors note that the present invention should be applicable to polypropylenes made by any metallocene catalyst.

In other embodiments, the polypropylene may be formed using a Ziegler-Natta catalyst. Ziegler-Natta catalysts or catalyst systems employing a Ziegler-Natta catalyst are described, for example, in U.S. Pat. Nos. 6,777,508 and 5,360,776 and US Patent publication 2010069586, which are herein incorporated by reference. In various embodiments, the Ziegler-Natta catalyst may include PTK 4320 which is more fully described in U.S. Pat. No. 6,107,231, which is also incorporated by reference. However, the inventors note that the present invention should be applicable to polypropylenes made by any Ziegler-Natta catalyst.

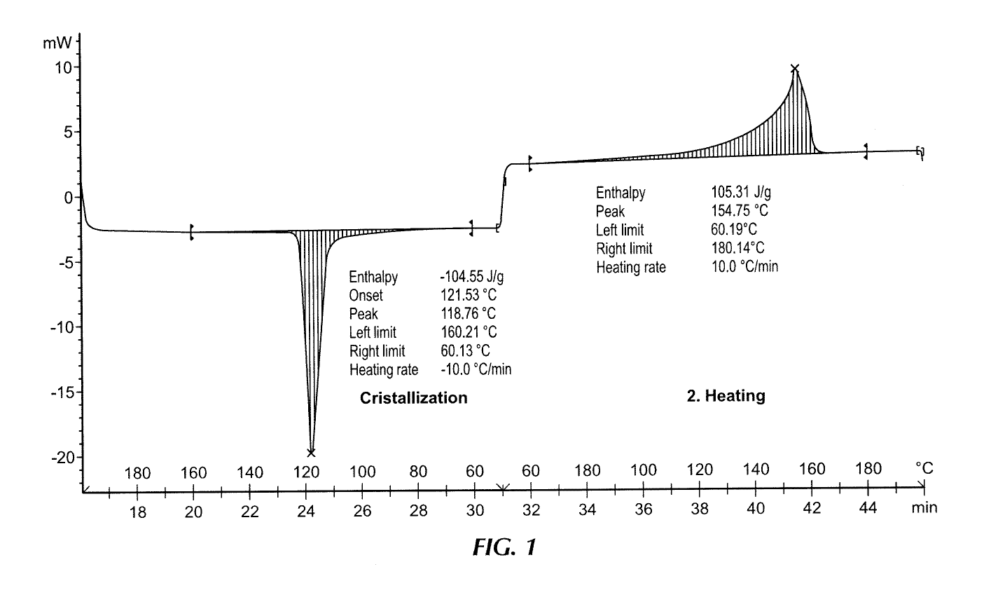

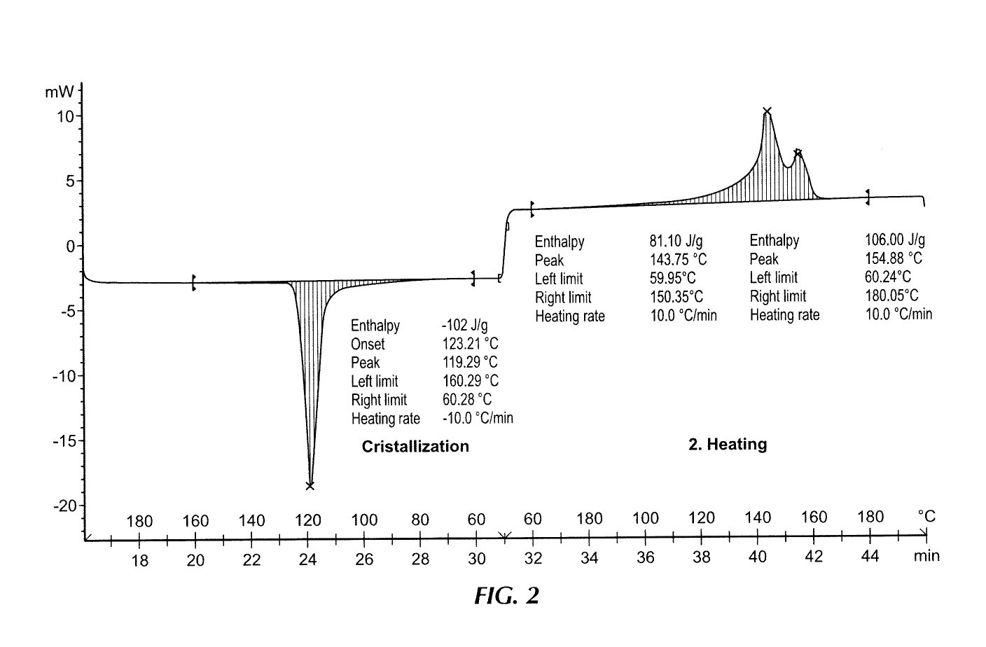

As noted above, metallocene polypropylenes may have a narrow melting range, compared to Ziegler-Natta polypropylenes, which may affect the bonding portion of the process to form spunbond or meltblown nonwovens. One useful analytical method of demonstrating the improved properties of the present invention is by comparing the DSC endotherm of inventive and non-inventive polypropylenes, as seen in FIGS. 1 (not beta nucleated) and 2 (beta nucleated). The DSC endotherm is created in accordance with ISO 11357. DSC endotherms are graphs plotting the energy provided to the polymer (in milliwatts) plotted against the temperature of the polymer.

In some embodiments, the useful polypropylenes herein may exhibit a DSC endotherm that exhibits a relatively gentle slope as the scanning temperature is increased past the highest temperature endotherm local maximum; this reflects a polymer of broad melting range rather than a polymer having what is generally considered to be a sharp melting point. The inventive embodiments will, in general, exhibit two or more local maximums in the DSC endotherm. However, this is not a requirement and some polypropylenes useful in embodiments disclosed herein have a single melting point. In some polypropylenes, one or more of the melting points may be sharp, such that all or a portion of the polymer melts over a fairly narrow temperature range, such as a few degrees centigrade. In other embodiments, the polymer may exhibit broad melting characteristics over a range of about 20° C. In yet other embodiments, the polymer may exhibit broad melting characteristics over a range of greater than 50° C.

Embodiments disclosed herein may include mixtures or blends of polymers, so long as at least one of the polymers is a polypropylene or a copolymer including polypropylene. Blends of polymers useful in embodiments disclosed herein may include one or more polypropylenes. Other blends useful in embodiments disclosed herein may include one or more polypropylenes and one or more additional polymers, such as polyethylene homopolymers and copolymers. Such polymers may be formed using the same or different type of catalyst or catalyst system.

Beta nucleating agents useful in embodiments disclosed herein induce the formation of beta-crystals in polypropylene, and may include various organic and inorganic nucleating agents, such as: the gamma-crystalline form of a quinacridone colorant Permanent Red E3B “Q-Dye;” the bisodium salt of o-phthalic acid; the aluminum salt of 6-quinizarin sulfonic acid; isophthalic and terephthalic acids; and N′,N′-dicyclohexyl-2,6-naphthalene dicarboxamide, also known as NJ Star NU-100, available from the New Japan Chemical Co.; nucleating agents based upon salts of rosin/adiebetic acid; zinc (II) monoglycerolate; nucleating agents based upon diamide compounds as disclosed in U.S. Pat. No. 6,235,823, such as N-cyclohexyl-4-(N-cyclohexylcarbonylamino)benzamide and N,N′-1,4-cyclohexane-bis-benzamide, for example; nucleating agents based upon trimesic acid derivatives, such as disclosed in WO 02/46300, WO 03/102069, WO 2004/072168, including, for example, 1,3,5-benzenetricarboxylic acid tris(cyclopentylamide), 1,3,5-benzenetricarboxylic acid tris(cyclohexylamide), and 1,3,5-benzenetricarboxylic acid tris(tert-butyl)amide.

Beta nucleating agents as described in JP 8144122, JP 7033895, CN 1568845 and JP11140719 may also be used. The inventor notes that while JP 11140719 discloses the use of beta nucleating agents to produce ultrafine polypropylene fibers, it does so for processes completely different from the current melt flow process. The process in JP 11140719 produces yarn by melt spinning the Polypropylene resin composition under slow cooling (that is, slow filament spinning speed) and then highly draws the undrawn (ie., fully crystallized) yarn. How “highly” a yarn is drawn is a term of art that describes a process in which the second godet speed is greater than the first godet's speed. The higher the difference in speeds between the two godets, the more “highly” drawn the yarn is considered to be.

This process in JP 11140719 (the drawing of undrawn yarn) is sharply in contrast to that of the present invention. The process in JP 11140719 describes the drawing of fully crystallized PP yarn whereas the present invention draws on the yarn prior to its full crystallization. The present invention produces filaments are not fully crystallized but rather drawn out of the still molten polymer, giving rise to the term “melt-drawing”.

Similarly, JP8144122 describes the drawing of the undrawn (i.e., fully crystallized) yarn to create porous Polypropylene fibers. The present invention does not draw undrawn yarn (the “cold” drawing process) and does therefore not create porous fibers. Attenuation in a cold draw process is produced by passing the fiber over godets rotating at differing speeds. For the production of porous fibers the “cold draw” is crucial as only the cold draw process could transfer the less dense beta-crystallites into higher density alfa-crystallites while creating porous areas. During the change-over from beta- to alfa-crystallites the beta-crystallites will be eliminated and the advantage of lower melting temperature and broader melting range as described in the present disclosure would not exist.

Common sense taught away from the use of nucleating agents for melt drawn and high speed melt spinning applications, especially spunbond nonwoven processing, because there is the presumption that their use would result in premature crystallization having negative effects on attenuation of the filaments and over-all process stability. The fiber produced from a melt draw process is attenuated by the air pressure in the cabin and not by drawing with a godet. It was commonly believed that premature crystallization would cause the fibers being drawn to have a larger diameter, and thus less polymer orientation along the axis of the draw, giving the fiber less tensile strength.

Other suitable beta nucleating agents are disclosed in DE 3,610,644, prepared from two components, (A) an organic dibasic acid, such as pimelic acid, azelaic acid, o-phthalic acid, terephthalic acid, and isophthalic acid; and (B) an oxide, hydroxide or an acid salt of a metal of Group II, such as magnesium, calcium, strontium, and barium. The acid salt of the second component (B) may be derived from an organic or inorganic acid, such as a carbonate or a stearate.

In various embodiments, the beta nucleating agents may include N′, N′dicyclohexyl-2,6 naphtalene dicarboxamid which may be commercially purchased as NJ-Star NU-100 from RIKA.

The beta nucleating agents may be used in the form of powders, pellets, liquids, other commonly available forms, or combinations thereof, for admixture (melt blending) with polypropylenes and/or other polymers used in forming fibers in BCF spunbonding or meltblowing processes disclosed herein. In other embodiments, the beta nucleating agent may be compounded with a polypropylene or other suitable polymers to form a beta nucleating additive master batch for admixture (melt blending) with additional polypropylenes and/or other polymers used in forming fibers in BCF spunbonding or meltblowing processes disclosed herein. Compositions including polypropylene(s) and beta nucleating agent(s) according to embodiments disclosed herein may be prepared by mixing or kneading the respective components at a temperature around or above the melting point temperature of one or more of the blend components. Typical polymer mixing or kneading equipment that is capable of reaching the desired temperatures and melt plastifying the mixture may be employed. These include mills, kneaders, extruders (both single screw and twin-screw), BANBURY® mixers, calenders, and the like. The sequence of mixing and methods may depend on the final composition as well as the form of the starting components (powder, pellet, liquid, masterbatch, etc.).

The beta nucleating agent may be used in an amount such that the overall polymer melt, as extruded to form fibers according to embodiments disclosed herein, contains from about 0.1 to about 10,000 ppm by weight beta nucleating agent; from about 1 to about 5,000 ppm by weight in other embodiments; and from about 10 to about 1000 ppm by weight in yet other embodiments.

The amount(s) and type(s) of beta nucleating agent used may depend upon a number of factors, including the type(s) of polypropylene, the thermal conditions under which the fibers are extruded and/or attenuated, the spinning speeds, thermal bonding conditions, and targeted fiber diameter, among other factors as may be readily apparent to one skilled in the art.

In addition to polypropylene(s) and beta nucleating agent(s), fibers formed according to embodiments disclosed herein may include other additives, which may be added during the polymerization process, compounded with a polymerization product, or added during the spunbonding or meltblowing process. Such additives may include processing oils, processing aids, plasticizers, cross-linking agents, anti-ozonants, anti-oxidants, hindered amine light stabilizers (HALS), UV absorbers, clarifiers, perfumes, algae inhibitors, anti-microbiological and anti-fungus agents, flame retardants and halogen-free flame retardants, slip and anti-block additives, inorganic fillers, colorants, liquid-absorbing materials, wetting agents, surfactants, anti-static agents, antifoam agent, anti block, wax-dispersion pigments, a neutralizing agent, a thickener, a compatibilizer, a brightener, flame retardants, moisturizing agents, a rheology modifier, a biocide, preservatives, a fungicide, energy absorbing agents, and other additives known to those skilled in the art.

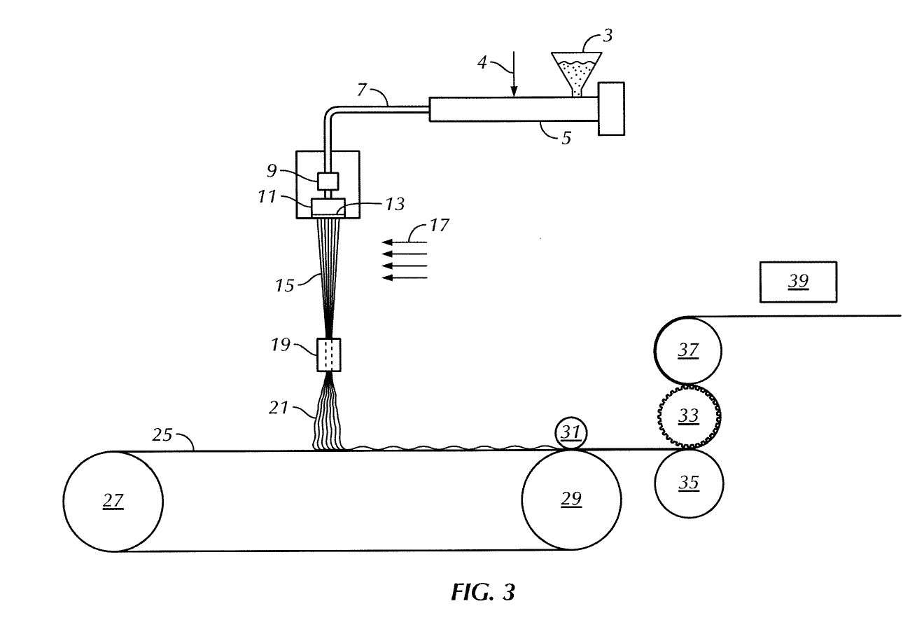

Referring now to FIG. 3, a process for forming a spunbond nonwoven according to one of the embodiments disclosed herein is illustrated. A polypropylene is fed via hopper 3 and a beta nucleating agent is fed via flow line 4 to screw extruder 5, where the polypropylene is melted and mixed with the beta nucleating agent. The polypropylene/beta nucleating agent blend is then fed through heated pipe 7 into metering pump 9 and spin pack 11, which may include a spinneret 13 with orifices through which fibers 15 are extruded. The extruded fibers 15 are quenched with a suitable quenching medium 17 (such as air or nitrogen) and are subsequently directed into a drawing unit 19, to increase the fiber velocity and to attenuate the fibers. Drawing unit 19 may attenuate the fibers using only air, or may employ godet rolls or other suitable means to attenuate the fibers. The spinning speed of the extruded fibers may be adjusted by controlling operating parameters of the metering pump 9, the drawing unit 19 and flow of mixture through the spin pack 11.

After exiting the drawing unit 19, the attenuated fibers 21 are laid down on a web forming surface, such as a continuous rotating screen belt 25 driven by rolls 27 and 29. The resulting web of fibers is conveyed through a compaction roll 31 to a nip formed by heated calender rolls 33 and 35 to bond the fibers in a selected pattern.

The bonded web is then passed over tension roll 37, which may prevent shrinkage and may be disposed at a selected location directly above upper calendar roll 33. Upon separating from the tension roll 37, the bonded web may be subjected to heat by a heat source 39. After heat treatment by heat source 39, the bonded and heat set web of fibers may be subjected to further processing and/or rolled onto a winder for further processing by other systems.

Attenuation of the fibers may be performed, as mentioned above, using godets, air, or nitrogen. The increase in process stability at higher spinning velocities allowed by use of beta nucleating agents, as disclosed herein, reduces the risk of filament breakage during the attenuation process, and allows a higher draw ratio, which leads to lower filament diameters. For a given polypropylene, filament diameters may be decreased by as much as 5, 10, 15, 20, 25, or even 50% or more without loss of process stability. Previous to the current invention, fiber diameters resulting after attenuation for polypropylene spunbound filament would face a lower denier limit of 1 dpf (denier per filament) and filament diameters would be in the range of 12 to 14 microns. Denier is an industry term for the weight of a yarn in grams for 9000 meters of the yarn. Denier per filament (dpf) is the same measure but only as applied to a single drawn filament. Employing the present invention, filament diameters would be in the range from about 0.1 microns to about 200 microns. Also, the denier of the polypropylene spunbound filaments can now be less than about 0.8 dpf, preferably less than 0.6 dpf, and more preferably and achievably about 0.4 dpf. For meltblown polypropylene the denier of the can now be less than about 0.05 dpf, preferably less than 0.02 dpf, and more preferably and achievably about 0.01 dpf.

Thermal bonding of the fibers, such as may occur using heated calender rolls 33, 35, and heat source 39 may also be improved by using beta nucleating agents according to embodiments disclosed herein. For example, the use of beta nucleating agents may result in the broadening of the melting range of a metallocene polypropylene, thus broadening the operating window for the thermal bonding process, improving overall operations and/or allowing higher processing speeds and lead via optimized bonding conditions to higher tensile strengths of the nonwoven.

The fibers and nonwovens produced according to embodiments disclosed herein may be useful in any of the applications in which polypropylene fibers and nonwovens are presently employed. Nonwovens produced according to various embodiments disclosed herein may include hygiene products, such as baby diapers, wipes, and pads, among others. Additionally, the fibers may be spunbond or meltblown into nonwoven webs utilized in various products including but not limited to, insulation fabrics, medical gauzes, and a variety of filtration products.

The incorporation of beta-nucleating agents into polypropylene compositions may provide higher fiber spinning stability at high velocities without increasing the risks of breaks in the fibers, higher line throughputs during the extrusion process for the production of fibers having smaller diameters, increased surface area and improved mechanical properties such as tensile strength. Thus, spunbond or meltblown nonwovens and BCF yarns may have smaller fiber diameters, increased surface area and improved mechanical properties and enhanced softness. When used in applications such as baby diapers, wipes, carpets, and pads, the smaller diameters may provide for at least one of increased surface area for improved absorbency and/or lighter weight products with enhanced mechanical strength and softness.

The present inventor has also found that additivation of polypropylene using a high concentration of a clarifier (MILLAD NX8000; 1,2,3-trideoxy-4,6:5,7-bis-O-((4-propylphenyl)-methylene)-nonitol available from Milliken Chemical—produces a similar effect as observed using beta nucleating agents, as described above. Enhanced spinning stability at high process velocities has been observed, for example, using NX8000 at concentrations in the range from about 1000 ppm to about 10000 ppm, by weight, preferably from about 2000 ppm to about 8000 ppm, more preferably from about 3000 to 4000 ppm.

### EXAMPLES

### Example 1

### Melt Properties

Sample 1

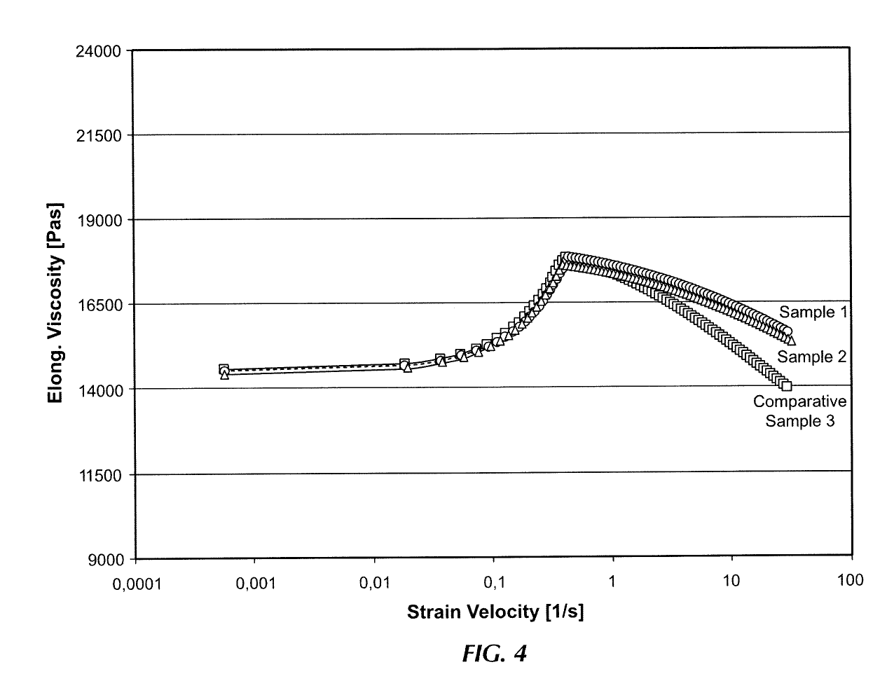

A metallocene polypropylene (mPP), formed using a metallocene catalyst (MCC A013) and having a melt flow rate of approximately 30 g/10 min (ISO 1133, 230° C. with 2.16 kg weight) is melt blended with a beta nucleating agent N′,N′dicyclohexyl-2,6 naphtalene dicarboxamid (commercially available as NJ-Star NU-100 from RIKA), at a loading of 300 ppm, by weight. Using the Rheotens Test (employing the Rheotens model 71.97 elongational viscosity tester from Göttfert) a curve of the strain velocity versus elongation viscosity (the speed of the filament uptake wheel of the Rheotens Test equipment) is produced. The Rheotens Test is conducted in the following manner. The Rheotens trial was performed by continuously extruding a polymer strand through a die with a length of 30 mm and a diameter of 2 mm which subsequently was received by the take-up wheels of the Rheotens equipment. The distance between the exit of the die and the nib point of the Rheotens take-up wheels was 100 mm. The experiment to determine the elongational viscosity begins by accelerating the take-up wheels of the Rheotens unit at 30 mm/s² until the polymer strand was ruptured. The draw down force to accelerate the polymer strand and the correlated speed is reported by the force transducer of Rheotens unit. The recorded force versus the speed will be used to calculate the elongational viscosity. A detailed description of the mode of operation of the Rheotens equipment is described in the U.S. Pat. No. 5,992,248, which is hereby incorporated by reference. The test results for the melt blend of the mPP with NJ-Star NU-100 as a beta nucleating agent are illustrated in FIG. 4.

Sample 2

A metallocene polypropylene (mPP), formed using a metallocene MCC A 013 catalyst and having a melt flow rate of approximately 30 g/10 min (ISO 1133, 230° C. with 2.16 kg weight) is melt blended with a nucleating agent which is also a clarifier, 1,2,3-trideoxy-4,6:5,7-bis-O-((4-propylphenyl)-methylene)-nonitol (commercially available as Milliken NX8000) at a loading of 4000 ppm, by weight. A curve of the strain velocity versus elongation viscosity for this polymer was produced using a Rheotens Test at conditions as indicated for Sample 1. The test results for the melt blend of the mPP with NX8000 are shown in FIG. 4.

Comparative Sample 3

A curve of the strain velocity versus elongation viscosity of the metallocene polypropylene (mPP) used in Samples 1-2, without an added beta nucleating agent, other nucleators or clarifiers were measured using a Rheotens Test at conditions as indicated for Sample 1. The test results are shown in FIG. 4.

As shown in FIG. 4, the nucleated metallocene polypropylene sample shows an increase in the elongation viscosity at very high strain velocities. The increased elongational viscosity at the high strain velocities indicates that the maximum reachable spinning speeds are higher for the nucleated mPP as compared to the non-nucleated sample, thus demonstrating improved process stability at higher spinning speeds.

### Example 2

### Spinning Tests

Sample 4

The mPP and beta nucleating agent as described for Sample 1 were tested on a high speed spinning line (using the Fourné Laboratory and Pilot Melt Spintester Spinning Line by Fourné Polymertechnik GmbH) to determine the maximum spinning speeds for the beta nucleated polypropylene. The polymer is melted in an extruder at temperatures between 220° C. and 230° C. The molten polymer is extruded through 18 dies of 0.25 mm diameter and an L/D ratio of 2. The filaments exiting the spinneret are then taken up by a take-up godet leading them over a second godet to the winder on which the final yarn is wound on spools. The take-up godet with adjustable speed defines the spinning speed of the filaments. The maximum spinning speed is reached when the filaments start to rupture. The test results are shown in Table 1.

Sample 5

The mPP blended with the nucleating agent as described for Sample 2 were tested on a high speed spinning line (a Fourné Spinning Line) to determine the maximum spinning speeds for the nucleated polypropylene, using a procedure similar to that described for Sample 4. The test results are shown in Table 1.

Comparative Sample 6

The mPP as described for Comparative Sample 3 were tested on a high speed spinning line (a Fourné Spinning Line) to determine the maximum spinning speeds using a procedure similar to that described for Sample 4. The test results are shown in Table 1. Titer is measure in the industry in unit of decitex (abbreviated dtex), which are 0.1 tex. A tex is defined as the mass of the filament per thousand (1000) meters of the filament. Therefore a 2 tex filament would be a filament that weighed 2 grams per 1000 meters of filament. The tensile strength is reported in an industry-used unit cN/tex which stands for centiNewtons per 1000 meters of fiber. Elongation is the percentage increase of length and is dimensionless but often is reported in meter per 100 meters.

TABLE 1

| | Comparative | | |
|---|---|---|---|
| | Sample 6 | Sample 4 | Sample 5 |
| Spinning speed | 3680 | 3850 | 3720 |
| max (m/min) | | | |
| Titer [dtex] | 2.0 | 1.1 | 1.9 |
| Tensile Strength | 24 | 25.5 | 25 |
| (cN/tex) | | | |
| Elongation | 188 | 166 | 173 |
| (m/m) (%) | | | |

As shown in Table 1, polypropylene compositions having beta-nucleating agents exhibit higher tensile strengths and are able to withstand higher spinning speeds during the drawing process. The maximum spinning speed of the beta nucleated mPP grades is higher leading to a smaller filament titer. The maximum spinning speed is the circumferential velocity of the godet speed when the filaments start to rupture. The filament titer is a calculation of the filament weight per 10,000 m length. (Typically in calculating the denier or titer, one of ordinary skill in the art determines the filament diameter under a microscope, and using the known density of the polymer, can produce the titer or denier from that measurement). Due to the higher maximum spinning speed of the nucleated samples, the mechanical properties are also influenced, exhibiting a higher tensile strength and lower remaining elongation. The mechanical properties, tensile strength and elongation, are measured on a tensile testing equipment “Statimat 4U” by Textechno H. Stein GmbH & Co. KG with a load cell of 10N, a gauge length of 250 mm and a testing speed of 250 mm/min.

### Example 3

Various blends of a metallocene polypropylene having a melt flow rate of approximately 30 g/10 min (ISO 1133, 230° C. with 2.16 kg weight), a beta nucleating agent (A=NJ-Star NU-100) and a nucleating agent (B=MILLAD NX8000) were formed as detailed in Table 2. Comparative samples included the metallocene polypropylene without a nucleating agent and a Ziegler-Natta polypropylene (PP 3155, an isotactic polypropylene having a melt flow rate of approximately 35 g/10 min, available from ExxonMobil Chemicals Corporation, Baytown, Tex.).

TABLE 2

| | Polymer | Nucleating | Nucleating Agent |
|---|---|---|---|
| | Type | Agent | Loading (ppm) |
| Comparative | mPP | — | — |
| Sample 7 | | | |
| Sample 8 | mPP | A | 500 |
| Sample 9 | mPP | A | 2000 |
| Sample 10 | mPP | B | 1000 |
| Sample 11 | mPP | B | 2000 |
| Sample 12 | mPP | B | 4000 |
| Comparative | Z/N PP | — | — |
| Sample 13 | | | |

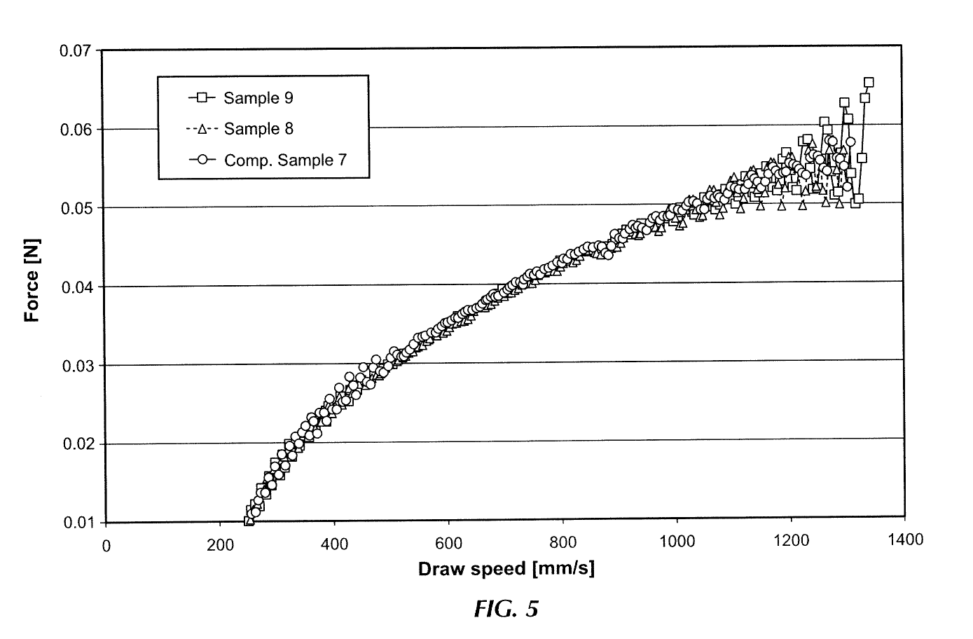

The properties of the melt are measured using a Rheotens Test as described above. The test results are illustrated in FIGS. 5-9.

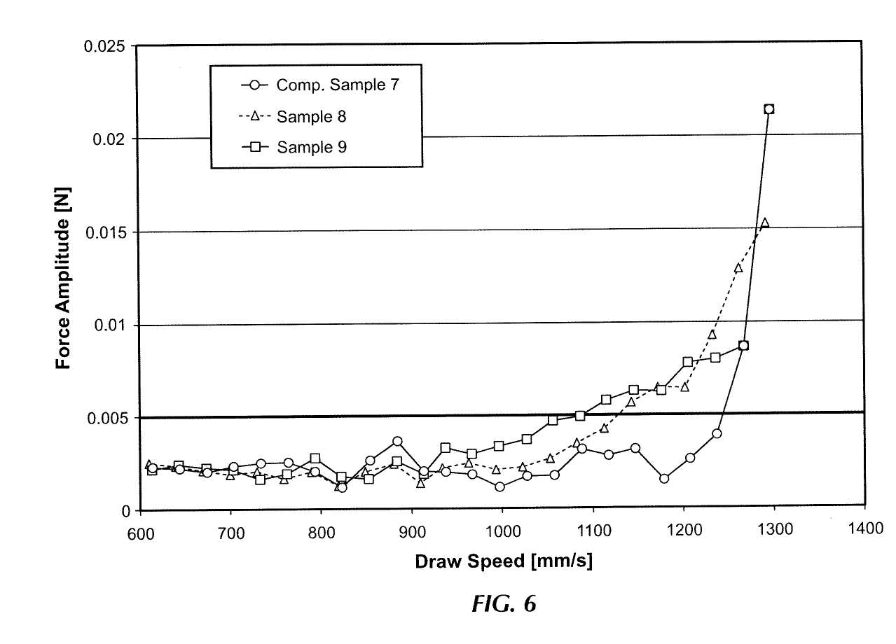

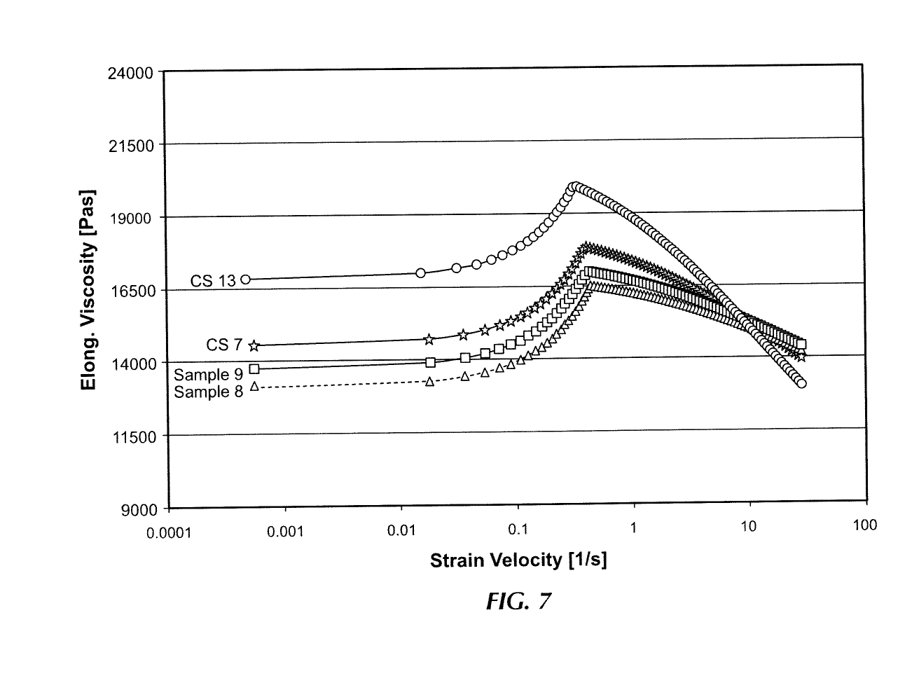

As shown in FIG. 5, nucleating agent “A” does not result in a change in the draw force required for the metallocene polypropylene. As shown in FIGS. 6-7, nucleating agent “A” indicates no influence on Draw Resonance Onset (the start of a pulsation in the fiber thickness due to the drawing of the filament) but a reduced elongational viscosity at lower spinning speeds. This indicates that spin stability is not negatively impacted by nucleator “A” even at extremely high spinning speeds while providing less resistance against draw, allowing a lower filament titer. The use of nucleating agent “A” also resulted in a lower decline in elongational viscosity (less slope in line at higher strain velocities), which indicates that the nucleated samples may be more stable with lower risk of “hot-breaks.” “Hot breaks” are filament ruptures which occur from the molten polymer due to too low melt strength. Melt strength is the resistance of a polymer to separate the polymer chains. Long polymer chains, for example, are highly entangled and provide higher resistance against disentanglement while slipping against each other over short chain polymers and provide therefore higher melt strength.

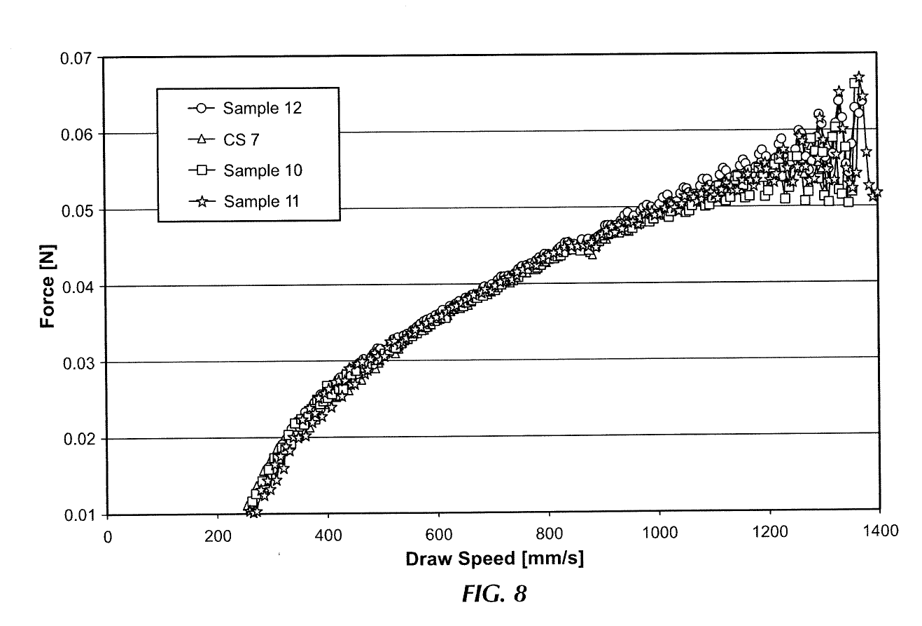

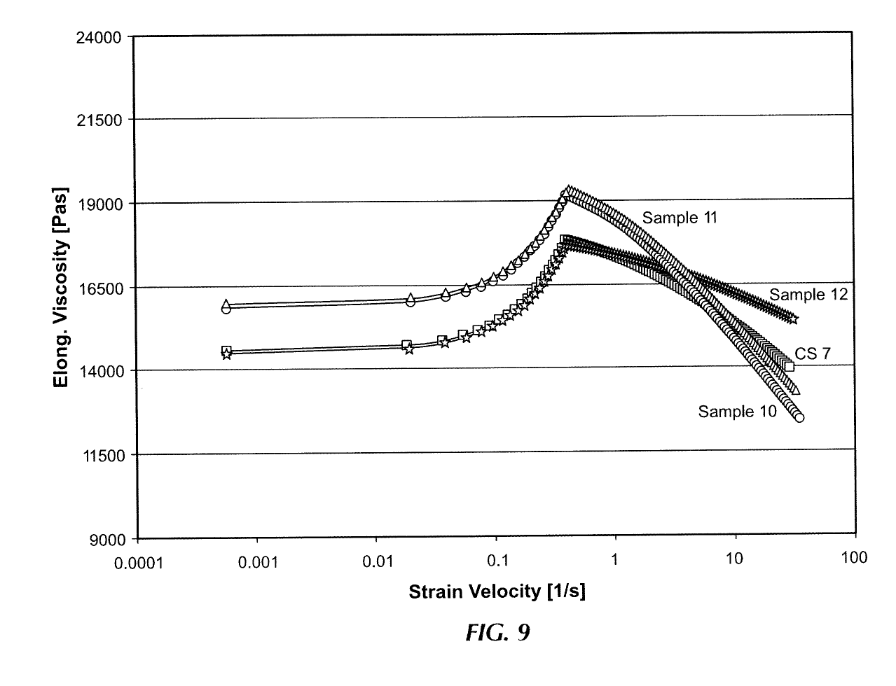

As shown in FIG. 8, nucleating agent “B” does not result in a change in the draw force required for the metallocene polypropylene. As shown in FIG. 9, Samples 10 and 11 showed an increase in elongational viscosity and a steeper slope of viscosity decrease, whereas Sample 12 did not influence elongational viscosity and showed less viscosity decrease, each as compared to Comparative Sample 7 (mPP with no nucleating agent). Nucleating agent “B,” when used at higher loadings with the mPP of this sample, results in an increased filament stability at higher spinning speeds (different results may be obtained for different polymers).

### Example 4

### Spunbond Nonwoven Test

Sample 14

A metallocene polypropylene (mPP), formed using a metallocene catalyst (MCC A013) and having a melt flow rate of approximately 40 g/10 min (ISO 1133, 230° C. with 2.16 kg weight) is melt blended with a beta nucleating agent (N′,N′dicyclohexyl-2,6 naphtalene dicarboxamid—or NJ-Star NU-100 from RIKA), at a loading of 500 ppm, by weight. The spinning properties were tested on a high speed spunbond nonwoven line (Reicofil model 4 spunbond line) as shown in FIG. 3. The spunbond nonwoven line was equipped with a spinneret with approx. 7000 holes/m having a diameter of 0.7 mm. The polymer resin was molten in an extruder at 240° C. and extruded through the dies to form filaments. The filament attenuation was accomplished by high speed air which is controlled by adjusting the pressure in the spinning cabin. The higher the pressure drop the higher is the velocity of the attenuation air and the resulting draw on the filament. The higher the cabin pressure, the faster the filaments exit the housing and the smaller the filament diameter. The attenuated filaments are randomly distributed onto a moving conveyor belt guiding the un-bonded filament fabric through a pair of hot rollers for thermal bonding. The results are shown in Table 3.

### Comparative Sample 15

Melt properties of the metallocene polypropylene (mPP) used in Samples 14, without the added beta nucleating agent was tested on a high speed spunbond nonwoven at test conditions indicated in Example 14. The results are shown in Table 3.

TABLE 3

| | Comparative | |
|---|---|---|
| | Sample 15 | Sample 14 |
| | mPP | mPP + Beta-Nucl. |
| Max. cabin pressure | 9000 | 10500 |
| [Pa] | | |
| Tensile strength MD | 26.8 | 34.4 |
| [N/5 cm] | | |
| Tensile strength CD | 12.2 | 13.6 |
| [N/5 cm] | | |

As shown in Table 3 the mPP blended with the beta-nucleator (Sample 14) shows a higher maximum cabin pressure as the comparative mPP without nucleation (Sample 15). This higher cabin pressure indicates to a higher spinning stability ending-up also in higher mechanical properties of the nonwoven fabric in MD (Machine Direction—direction parallel to the movement of the conveyor belt) and in CD (Cross Direction—transvers to MD) (different results may be obtained at different process settings). These mechanical properties are analyzed on a Instron Tensile Tester according to DIN EN 29073 with a gauge distance of 100 mm and a testing speed of 100 mm/min.

### Example 5

The inventors also noted that the present invention was effective on polypropylenes formed using Ziegler-Natta catalysts. The testing is the same as described in Example 2. While the results are not as significant as for metallocenes (possibly because of the broader molecular weight distribution of Ziegler-Natta over metallocenes), they still show the same trending effect of the invention. The results are reported in Table 4.

TABLE 4

| | Comparative | |
|---|---|---|
| | Sample 16 | Sample 17 |
| | (Z/N) | (Z/N + beta-nucl.) |
| MFR (g/10 min) | 24.8 | 25.5 |
| Spinning speed | 3790 | 3810 |
| max (m/min) | | |
| Titer [dtex] | 0.65 | 0.63 |
| Tensile Strength | 22.4 | 23.0 |
| (cN/tex) | | |

As described above, embodiments disclosed herein provide for meltblowing or spunbonding of polypropylene fibers and BCF yarns using a beta nucleating agent. Use of beta nucleating agents according to embodiments disclosed herein may provide for one or more of: increased throughput through the spunbonding nonwoven and BCF production process while maintaining product quality; the ability to produce smaller filaments at constant throughput, which may provide for better fabric uniformity, enhanced coverage, increased barrier, decreased nonwoven basis weight, and/or enhanced nonwoven and yarn softness; and the ability to apply higher draw forces to result in higher filament, yarn and nonwoven tenacity. Further, the use of beta nucleating agents may broaden the thermal bonding process window, leading to easier and less critical overall processing. Optimization of the bonding process may also have a positive effect on the tensile strength of the resulting nonwoven.

Use of beta nucleating agents according to embodiments disclosed herein may also provide for one or more of: higher gloss or shininess due to the smaller crystallites of the nucleated material; a higher dull (depending on concentration of beta nucleator), which could lead to savings in titanium oxide usage; an increase in elongation properties of the nonwoven and the yarn; enhanced UV stability due to heightened light scattering caused by the smaller crystal structure; enhanced crimp behavior of yarns produced from such filaments; and easier lamination to other substrates due to broader melting temperatures.

While the disclosure has been described with respect to a limited number of embodiments, those skilled in the art will appreciate that other embodiments can be devised which do not depart from the scope of the disclosure as disclosed herein. Accordingly, the scope of the disclosure should be limited only by the attached claims.

What is claimed:

1. A process to produce polypropylene fibers for nonwoven webs, comprising:
extruding a mixture comprising a polypropylene and a beta-nucleating agent to form fibers.

2. A process to produce polypropylene yarn from the Bulk Continuous Fiber Process, comprising:
extruding a mixture comprising a polypropylene and a beta-nucleating agent to form fibers.

3. The process of claim 1 or 2, further comprising attenuating the fibers.

4. The process of claim 3, wherein the attenuating is performed with air.

5. The process according to claim 1, further comprising at least one of the following steps:
blending the polypropylene and the beta-nucleating agent to form a mixture prior to or during extrusion;
quenching the fibers;
forming a web with the fibers; and
bonding the fibers.

6. The process according to claim 1 or 2, wherein the polypropylene comprises at least one of polypropylene homopolymers, polypropylene block copolymers, polypropylene impact copolymers, polypropylene random copolymers, and combinations thereof.

7. The process according to claim 1 or 2, wherein the polypropylene was formed using a metallocene or Ziegler-Natta catalyst.

8. The process according to claim 7, wherein the metallocene catalyst comprises MCC A013 metallocene catalyst.

9. The process according to claim 1 or 2, wherein the beta-nucleating agent comprises at least one containing halogens, metal salts of organic acids, aliphatic, cycloaliphatic and aromatic carboxylics, dicarboxylic or higher polycarboxylic acids, corresponding anhydrides and metal salts of dicarboxylic or higher polycarboxylic acids, cyclic bis-phenol phosphates, alkali metal carboxylate in polyvalent metal salt of organophosphoric esters, bicyclic dicarboxylic acid and salts, sodium benzoate, sodium 2,2′-methylene-bis-(4,6-di-tert-butylphenyl) phosphate, quinacridone dyes, beta-nucleating agent prepared from an organic dibasic acid and an oxide, hydroxide or an acid salt of a metal of Group II, or combinations thereof.

10. The process according to claim 9, wherein the beta nucleating agent comprises N′,N′dicyclohexyl-2,6 naphtalene dicarboxamid.

11. The process according to claim 1 or 2, wherein the mixture comprises 0.1 to 10000 ppm of the beta-nucleating agent.

12. The process according to claim 3, wherein the attenuated fiber has an average diameter in the range of from about 0.1 micron to about 200 micron.

13. The process of claim 1 wherein the nonwoven web is produced using the spunbonding process.

14. The process of claim 1 wherein the nonwoven web is produced using the meltblown process.

15. A process to produce nonwoven webs by the spunbonding process, comprising:
a. blending a polypropylene and a beta-nucleating agent to form a mixture;
b. extruding the mixture to form fibers;
c. quenching the fibers;
d. forming a web with the fibers; and
e. bonding the fibers.

16. A process to produce bulked yarn by the Bulk Continuous Fiber process, comprising:
a. blending a polypropylene and a beta-nucleating agent to form a mixture;
b. extruding the mixture to form yarns;
c. quenching the yarns;
d. crimping the yarns;
e. winding the yarns on bobbins.

17. A process to produce nonwoven webs by the meltblown process, comprising:
a. blending a polypropylene and a beta-nucleating agent to form a mixture;
b. extruding the mixture to form fibers;
c. quenching the fibers;
d. forming a web with the fibers; and
e. bonding the fibers.

18. A process as in any of claim 1, 2, 4, 13, 14, 15, 16, or 17, wherein the process is performed using 1,2,3-trideoxy-4,6:5,7-bis-O-((4-propylphenyl)-methylene)-nonitol in place of the beta-nucleating agent.

19. The process of claim 18, wherein the mixture contains from about 1000 ppm to about 10000 ppm of the 1,2,3-trideoxy-4,6:5,7-bis-O-((4-propylphenyl)-methylene)-nonitol.
